(19) United States
(12) Patent Application Publication
(10) Pub. No.: US 2024/0095815 A1
(43) Pub. Date: Mar. 21, 2024

(54) MIXED REALITY PRESENTATION BASED ON A VIRTUAL LOCATION WITHIN A VIRTUAL MODEL OF A PHYSICAL SPACE

(71) Applicant: Lowe's Companies, Inc., Mooresville, NC (US)

(72) Inventors: Mason E. Sheffield, Woodinville, WA (US); Frank Irving, Woodinville, WA (US); Ryan James Favale, Woodinville, WA (US); Joseph Laurino, Sammamish, WA (US); Deane Mcgahan, Shoreline, WA (US); Kara Gundersen, Woodinville, WA (US)

(21) Appl. No.: 17/946,946

(22) Filed: Sep. 16, 2022

(51) Int. Cl. G06Q 30/06; G06T 19/00

(52) U.S. Cl. CPC G06Q 30/0643; G06Q 30/0639; G06T 19/006

(57) ABSTRACT

A modeling system determines a physical location of a device in a store and a virtual location in a virtual model of a store that corresponds to the physical location. The modeling system determines, from the virtual model, a subset of model data based on the virtual location. The model data comprises store location data applicable to the entire store, shelf data applicable to shelves in the store, and planogram data applicable to the shelves and products associated with the shelves. The subset of model data comprises the store location data, a subset of the shelf data applicable to at least a shelf within a predefined distance of the physical location of the device, and a subset of the planogram data applicable to at least the shelf and a product associated with the shelf. The modeling system generates a presentation of a scene based on the subset of model data.

### TECHNICAL FIELD

This disclosure generally relates to three-dimensional (3D) modeling in support of virtual and/or augmented reality applications. More specifically, but not by way of limitation, this disclosure relates to providing model data to a user device for generating mixed reality (AR and/or VR) presentations.

### BACKGROUND

Modeling objects for display in computer-based simulated environments (e.g., virtual reality environments and/or augmented reality environments) can be useful for applications in the physical world. For example, virtual models of physical resets (e.g., shelves including stacked or otherwise arranged objects) can be displayed in a virtual reality environment and/or an augmented reality environment to help the viewer assemble the physical resets in a physical environment.

However, conventional virtual modeling systems for augmented reality environments suffer from inaccurate, uncalibrated rendering of scenes. Further, the conventional virtual modeling system may suffer latencies in scene rendering because they must process render a scene from an entire virtual model.

### SUMMARY

The present disclosure describes techniques for providing, by a virtual modeling system to a user device, a subset of model data corresponding to a location of the user device for generating augmented reality presentations.

In certain embodiments, the modeling system determines a physical location of a device in a store and determines a virtual location that corresponds to the physical location. The virtual location is in a virtual model that represents the store. The modeling system determines, from the virtual model, a subset of model data based on the virtual location. The model data comprises (i) store location data applicable to the entire store, (ii) shelf data applicable to shelves in the store, and (iii) planogram data applicable to the shelves and products associated with the shelves. The subset of the model data comprising (iv) the store location data, (v) a subset of the shelf data applicable to at least a shelf within a predefined distance of the physical location of the device, and (vi) a subset of the planogram data applicable to at least the shelf and a product associated with the shelf. The modeling system generates a presentation of a scene based on the subset of the model data, the presentation showing a visual representation of the product overlaid on an image of the shelf within the scene.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates an example of a computing environment for providing, by a modeling system to a user device, a subset of model data corresponding to a location associated with a marker for display of a mixed reality view of a store environment via the user device, according to certain embodiments disclosed herein.

FIG. 2 depicts an example of a computing environment for providing, by a modeling system to a user device, subsets of model data corresponding to various locations of the user device, according to certain embodiments disclosed herein.

FIG. 3 depicts an example of a computing environment for providing, by a modeling system to a user device, a subset of model data corresponding to a location of the user device for generating augmented reality presentations, according to certain embodiments disclosed herein.

FIG. 4 depicts an example of a method for providing, by a modeling system to a user device, a subset of model data corresponding to a location of the user device for generating mixed reality presentations, according to certain embodiments disclosed herein.

FIG. 5 depicts an example of a method for generating model data for use in the computing environments of FIG. 1, FIG. 2, and FIG. 3 and in the method of FIG. 4, according to certain embodiments disclosed herein.

FIG. 7 depicts an example of a computing system that performs certain operations described herein, according to certain embodiments described in the present disclosure.

FIG. 8 depicts an example illustration of a mixed reality view, according to certain embodiments described in the present disclosure.

FIG. 9 depicts an illustration of location-based statistical data displayed in a mixed reality view, according to certain embodiments described in the present disclosure.

FIG. 10 depicts an illustration of an example distance map that can be displayed in the mixed reality view, according to certain embodiments described in the present disclosure.

FIG. 11 depicts an example illustration of an x-ray view mode of a mixed reality view, according to embodiments described in the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

With reference to the embodiments described herein, a computing environment may include a modeling system, which can include a number of computing devices, modeling applications, and a data store. The modeling system may be configured to store a virtual model of a store or other physical environment (e.g., an appliance store, a grocery store, a business location, a manufacturing plant, a library, etc.). The virtual model of the store can include a layout of the store that corresponds to a real-world layout of the store, including walls, aisles, shelves, and other aspects of the spatial layout of the store. The virtual model of the store virtual objects corresponding to real-world objects and arrangements of virtual objects (e.g., resets including shelving and/or arranged objects). The virtual model of the store can be presented in a computer-based simulated environment, such as in a virtual reality environment and/or an augmented reality environment.

The following non-limiting example is provided to introduce certain embodiments. In this example, a modeling system determines a physical location of a user device in a store. In some embodiments, the modeling system determines a location of the user device based on the user device scanning a physical marker (e.g., a fiducial marker having a known pattern that identifies the marker and/or characteristics of the marker such as its dimensions) corresponding to a known location in the store using a camera of the user device. In some embodiments, the modeling system determines the location of the user device based on global positioning system (“GPS”) or other location data or positional data (e.g., orientation data, accelerometer data, gyroscope data) received from the user device. In some embodiments, the modeling system determines the location of the user device by detecting the user device via a device (e.g., camera, beacon device) at a known location in the store. For example, a beacon device at the store that communicates with the modeling system detects a beacon broadcast by the user device application when the user device is within a predefined distance to the beacon device and the modeling system determines that the user device is at the known location of the beacon device within the store. In another example, a camera device at the store that communicates with the modeling system detects the user device (or user of the user device) in a field of view of the camera and the modeling system determines the user device location based on a position of the user device (or the user) within the field of view. In certain examples, the modeling system determines a position of the user device, for example a location and an orientation of the user device.

Subsequently, the modeling system can determine a virtual location of a virtual model that corresponds to the physical location or of the user device in the store. In some instances, the modeling system can determine a virtual location of a virtual model that corresponds to the position (e.g., the location and the orientation of) the user device in the store. The virtual model can include model data that represents the store. For example, the virtual model can include store location data that is applicable to the entire store. In some embodiments, location data includes location coordinates that define locations within the virtual model that correspond to locations in the physical store. In some embodiments, the virtual location data includes reference markers associated with corresponding physical reference markers at known physical locations in the store that can be detected by a camera device of a user device in the store. In some embodiments, location data can include location coordinates for the virtual model that correspond to or are based on real world global positioning system (“GPS”) data describing a layout of the physical store.

The modeling system can extract, from the model data, a subset of the model data. The subset includes a subset of the store location data, a subset of the shelf data, and a subset of the planogram data. For example, the subset of the store location data can include a two-dimensional (2D) layout of the store including locations of shelves within the store (e.g., a spatial blueprint of the store). For example, the subset of the shelf data can include shelf data (e.g., a vertical dimension of a shelf, a number and/or height of individual shelves in a shelving unit) applicable to at least a shelf within a predefined distance of the physical location of the device. For example, the subset of the planogram data can include planogram data applicable to at least the shelf (of the subset of shelf data) and a product associated with the shelf.

The modeling system can generate a presentation of a scene based on the subset of the model data. The presentation could be an augmented reality scene or a virtual reality scene of the environment of the user device that shows, from the retrieved subset of model data, a visual representation of the product overlaid on an image of the shelf within the augmented reality scene.

Providing location-specific subsets of model data to user devices, as described herein, provides several improvements and benefits over conventional techniques. For example, embodiments of the present disclosure provide a modeling system that enables selective transmission of location-specific (or position-specific) subsets of model data to a user device for rendering of scenes without the need for transmitting the entire model data and/or rendering a scene from the entire model data. Certain embodiments described herein address the limitations of conventional modeling systems by selecting a subset of model data to transmit to the user device based on a current detected location (or position including a location, orientation, or other user device information) of the user device. By only transmitting or otherwise making available the subset of model data for scene rendering on the user device that corresponds to the current detected location of the user device, the accuracy of the rendered scene is improved because only locally-relevant model data will be considered for rendering the scene. Further, only transmitting or otherwise making available the subset of model data for scene rendering on the user device that corresponds to the current detected location of (or position of) the user device, the speed of scene rendering for display on the user device is increased because the scene does not need to be rendered based on the entire model data and also usage of computing resources is reduced by only having to transmit to and/or store the location-specific subset of model data to the user device instead of the entire model data.

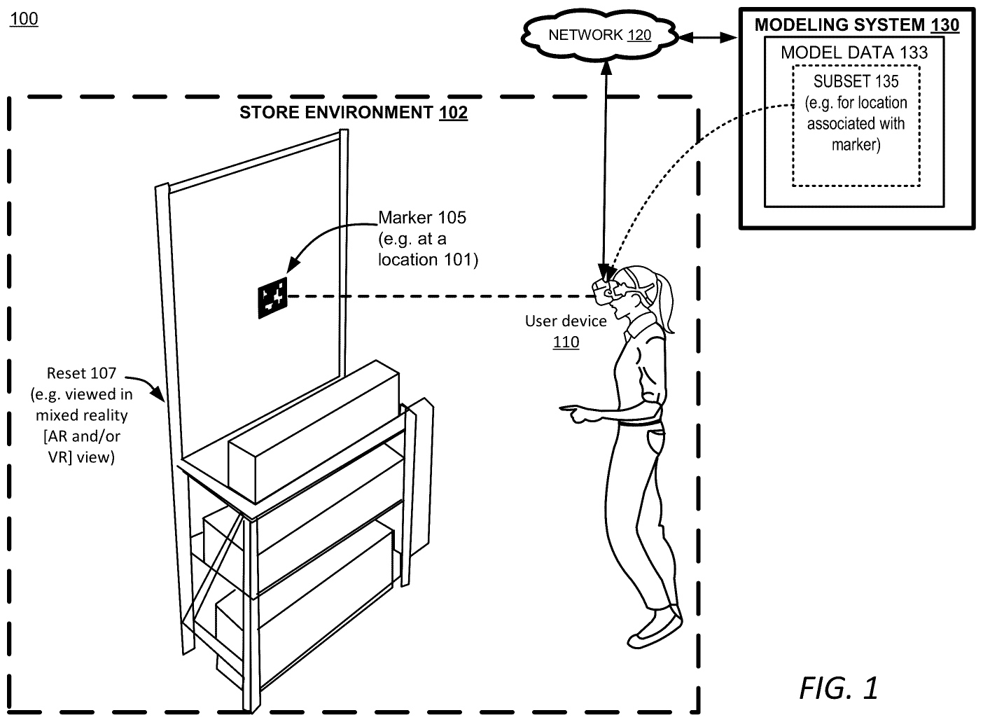

Referring now to the drawings, FIG. 1 depicts an example of a computing environment 100 for providing, by a modeling system 130 to a user device 110, a subset 135 of model data 133 corresponding to a location 101 associated with a marker 105 for display of a mixed reality view of a store environment 102 via the user device 110. The modeling system 130 can include one or more processing devices that execute one or more modeling applications. In certain embodiments, the modeling system 130 includes a network server and/or one or more computing devices communicatively coupled via a network 120. The modeling system 130 may be implemented using software (e.g., code, instructions, program) executed by one or more processing units (e.g., processors, cores), hardware, or combinations thereof. The software may be stored on a non-transitory storage medium (e.g., on a memory device). The computing environment 100 depicted in FIG. 1 is merely an example and is not intended to unduly limit the scope of claimed embodiments. Based on the present disclosure, one of the ordinary skill in the art would recognize many possible variations, alternatives, and modifications. In some instances, the modeling system 130 provides a service that enables display of virtual objects in an augmented and/or virtual reality environment for users, for example, including a user associated with a user device 110. In the example depicted in FIG. 1, a user device 110 detects a marker 105 (as indicated by the dashed line from the marker 105 to the user device 110) at a location 101 of a store environment 102 and the modeling system 130 determines the location 101 of (or in some instances, the position of) the user device 110 associated with the scanned marker 105. For example, the user device 110 detects the marker 105 in a field of view of a camera device of the user device 110. As depicted in the example of FIG. 1, the modeling system 130 can transmit, via the network 120, a subset 135 of model data 133 associated with the detected location 101 (or position) of the user device 110. For example, the model data 133 represents a complete, full model of the store environment 102 and the subset 135 of the model data 133 represents a particular area of the store environment 102 at the location. As depicted in FIG. 1, the user can display, in a mixed reality view, a reset 107, as depicted in FIG. 1, based on the subset 135 of model data 133 received at the user device 110. The mixed reality view can include an augmented reality (AR) view and/or a virtual reality (VR) view. In an example AR view, the reset 107 could be a physical object in the store environment 102 and, in the AR view, the user device 110 displays a camera view of the user device 110, which shows the empty reset 107 and the user device 110 superimposes virtual objects (e.g., products, items) arranged on the shelves of the reset 107. In an example VR view, the reset 107 and the products/items arranged thereon are virtual objects displayed in a virtual space. Although the marker 105 in FIG. 1 is affixed to the reset 107, the marker 105 could be positioned at any known location 101 in the store environment 102 (e.g., on a wall, on a ceiling, on a floor). In some examples, the user can provide inputs to the user device 110 to swap between a VR view and an AR view.

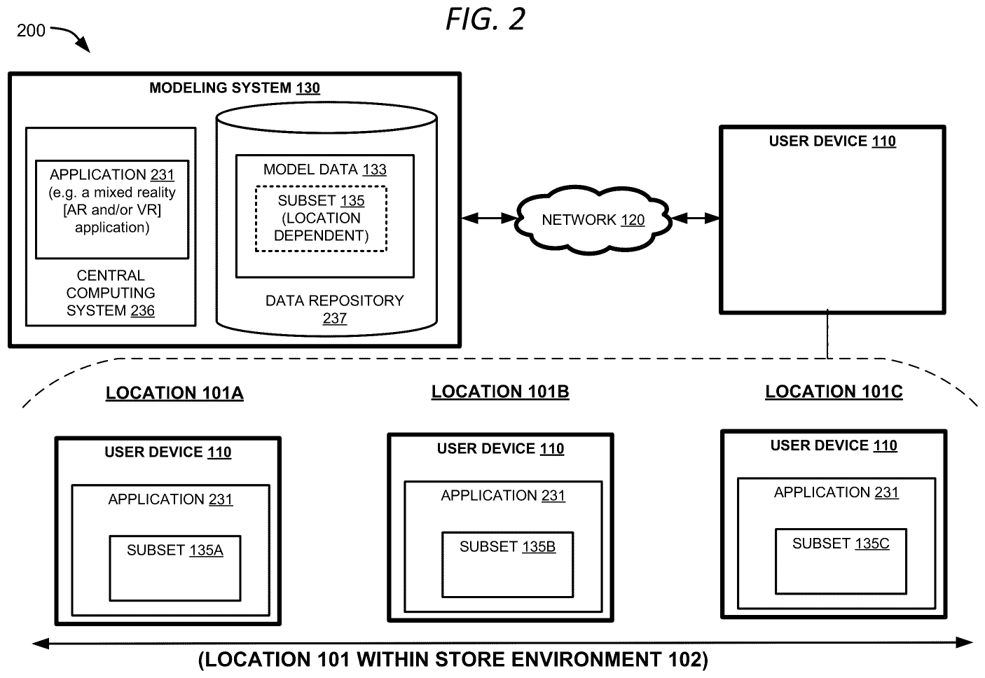

FIG. 2 depicts an example of a computing environment 200 for providing, by a modeling system 130 to a user device 110, subsets of model data 133 corresponding to various locations 101 of the user device 110, in accordance with certain embodiments described herein. The computing environment 200 of FIG. 2 provides further details concerning the computing environment 100 of FIG. 1. Elements that are found in FIG. 1 are further described in FIG. 2 and referred thereto using the same element numbers. In certain embodiments, the modeling system 130 includes a central computer system 236, which supports an application 231. The application 231 could be a mixed reality application. For example, a mixed reality includes an augmented reality (“AR”) and/or a virtual reality (“VR”). The application 231 enables a presentation of a virtual model of the store environment 102 in an augmented reality and/or virtual reality scene. The application 231 may be accessed by and executed on a user device 110 associated with a user of one or more services of the modeling system 130. For example, the user accesses the application 231 via a web browser application of the user device 110. In other examples, the application 131 is provided by the modeling system 130 for download on the user device 110. As depicted in FIG. 2, the user device 110 communicates with the central computer system 236 via the network 120. Although a single user device 110 is illustrated in FIG. 2, the application 231 can be provided to (or can be accessed by) multiple user devices 110.

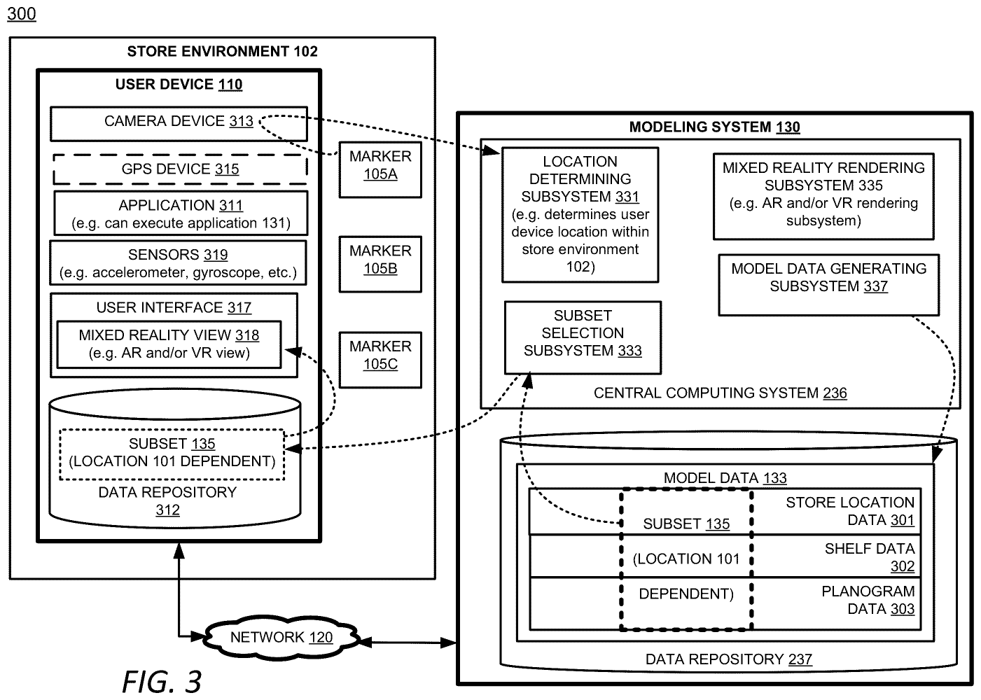

In certain embodiments, the modeling system 130 comprises a data repository 237. The data repository 237 could include a local or remote data store accessible to the central computer system 236. In some instances, the data repository 237 is configured to store model data 133 associated with a virtual model of the store environment 102. As shown in FIG. 2, the model data 133 is divisible into subsets 135 that can be provided to the user device 110 based on a determined location 101 of the user device 110. In some instances, the data repository 237 is configured to store the model data 133 which defines store location data, shelf data, and planogram data for the virtual model of the store environment 102. The store location data can include a 2D layout of the store that indicates one or more locations of shelves of the store. Shelf data can include dimensions of shelves indicated in the location data. For example, the location data could include horizontal dimensions of a shelf unit (e.g., length and width) and the shelf data could indicate a vertical dimension (e.g., height) of the shelf unit or other data describing the shelf unit (e.g., heights of individual shelves of the shelf unit). In addition to shelves, shelf data can also provide dimensions of other structures or areas such as resets, floors, shelving units, or other structures or areas which are configured to support products. For example, planogram data could include products and/or virtual objects associated with and/or arranged on shelves. Further details about the model data 113 and subsets 135 of the model data 133, as well as details about the types of model data 133 (e.g., location data, shelf data, planogram data) are described in FIG. 3 herein. The user device 110 also can communicate with the data repository 237 via the network 120.

As depicted in FIG. 2, in some examples, the user device 110 executes the application 231 to access various subsets 135 (e.g., subset 135A, 135B, and 135C) of model data 133 corresponding to a current location 101 of the user device 110, as shown in the lower section of FIG. 1. For example, when the modeling system 130 determines that the user device 110 is at or within a predefined proximity to location 101A (e.g., the user device 110 scans a marker 105 associated with location 101A, for example, as depicted in FIG. 1), the modeling system 130 extracts a subset 135A of the model data 133 and provides the subset 135A to the application 231, which can be used by the user device 110 to generate a mixed reality view (e.g., an VR and/or AR view) of the environment of the user device 110. For example, when the modeling system 130 determines that the user device 110 is at or within a predefined proximity to location 101B, the modeling system 130 extracts a subset 135B of the model data 133 and provides the subset 135B to the application 131, which can be used by the user device 110 to generate a mixed reality view of the environment of the user device 110. For example, when the modeling system 130 determines that the user device 110 is at or within a predefined proximity to location 101C, the modeling system 130 extracts a subset 135C of the model data 133 and provides the subset 135C to the application 131, which can be used by the user device 110 to generate a mixed reality view of the environment of the user device 110. In some embodiments, the subsets 135A, 135B, 135C are predefined subsets 135 associated with predefined locations 101A, 101B, and 101C within the store, respectively and the modeling system 130 retrieves the respective subset 135 (e.g., subset 135A) responsive to determining that the user device 110 is located at the corresponding respective location 101 (e.g., location 101A) within the store environment 102. However, in some embodiments, the modeling system 130 generates a subset 135 based on a determined location 101 of the user device 110 by extracting the subset 135 from the model data 133 responsive to detecting the location 101 of the user device 110. In some embodiments, each subset 135 is associated with a range or area of the store and the modeling system 130 provides a subsequent subset 135 when the user device 110 is determined to be located outside of the range or area of the current subset 135 of the model data 133.

FIG. 3 depicts an example a computing environment 300 for providing, by a modeling system 130 to a user device 110, a subset 135 of model data 133 corresponding to a location 101 of the user device 110 for generating augmented reality presentations, according to certain embodiments disclosed herein.

The computing environment 300 of FIG. 3 provides further details concerning the computing environment 100 of FIG. 1 and concerning the computing environment 200 of FIG. 2. Elements that are found in one or more of FIG. 1 or FIG. 2 are further described in FIG. 3 and referred thereto using the same element numbers.

The computing environment 300 includes the modeling system 130. The modeling system 130, in certain embodiments, includes a location determining subsystem 331, a subset selection subsystem 333, a mixed reality rendering subsystem 335, and a model data generating subsystem 337. The mixed reality rendering subsystem 335 can include an augmented reality (AR) rendering subsystem and/or a virtual reality (VR) rendering subsystem. In some instances, the location determining subsystem 131 is a position determining subsystem.

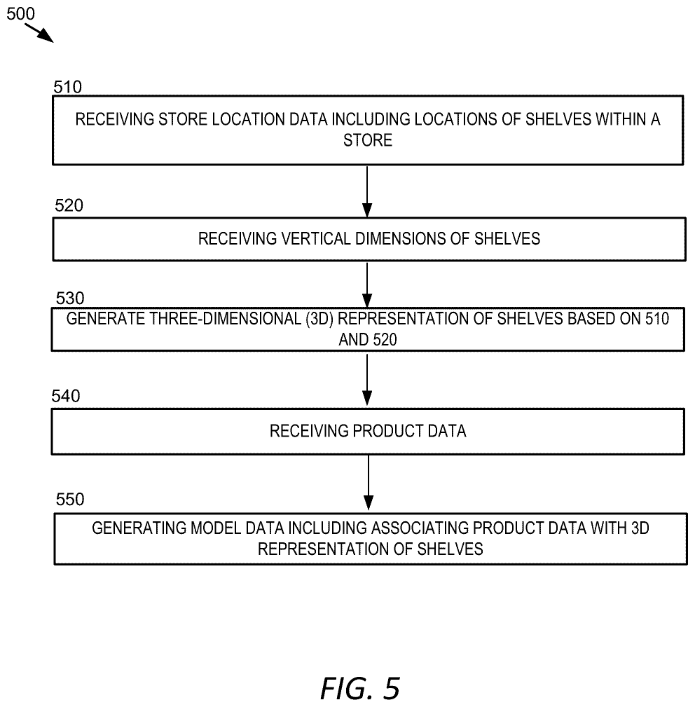

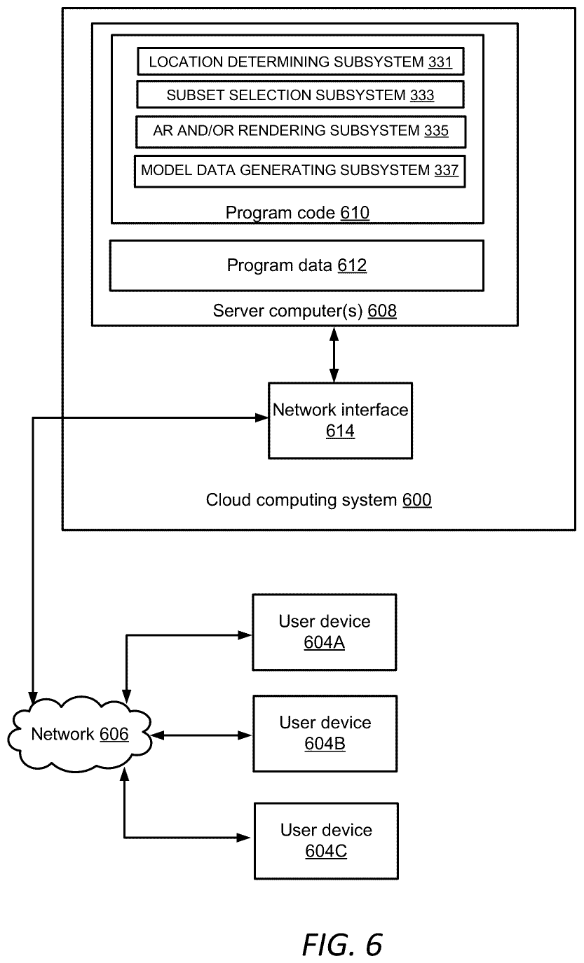

In certain embodiments, the model generating subsystem 337 is configured to generate model data 133 associated with a store and store the model data 133 in the data repository 237. In certain embodiments, the model data generating subsystem 337 generates model data 133 representing a virtual model of the store. In certain embodiments, the model data 133 includes store location data 301, shelf data 302, and planogram data 303. Store location data 301 can include a 2D layout (e.g., blueprint) of the store environment 102 including horizontal dimensions (e.g., length and width) of features of the store including aisle locations, shelf unit locations, wall locations, etc. Shelf data 302 can include, for shelf units/areas identified in the store location data 301, vertical dimensions (e.g., a height of the shelf unit from a floor plane) of the shelf unit/area or other features of the shelf unit/area. Shelf data 302 can also provide dimensions of other structures or areas such as resets, floors, shelving units, or other structures or areas which are configured to support products. The other features could include a number of shelves on the shelf unit, a height of each shelf from a floor plane. Planogram data 303 can include virtual object data (e.g., virtual object representations of products or other items), which can be associated with shelf data 302. As depicted in FIG. 3, the model data 133 is stored so that subsets 135 of the model data 133 can be extracted by the subset selection system 333. In some embodiments, the model data generating subsystem 337 divides the model data 133 into a plurality of subsets 135 of the model data 133 and associates each subset 135 with a location 101 within the store. For example, a store could comprise an area of 20,000 square yards and the model data generating subsystem 337 could divide the are into ten, twenty, fifty, or other predefined number of subregion (e.g., ten 2,000 square yard regions) and associate a particular subset 135 of the model data 133 with each of the predefined subregions. For example, for a subregion, the model data generating subsystem 337 generates and/or defines a subset 135 of the model data 133 that corresponds to the area of the subregion. For example, the subset 135 includes a subset of store location data 301 encompassed by the area of the subregion of the store, shelf data 302 encompassed by the subset of store location data 202 and planogram data 303 associated with the subset of shelf data 302. In other embodiments, however, the model data generating subsystem 337 does not generate predefined subsets 135 of the model data 133 for selection by the subset selection subsystem 333. Further details describing how the model data generating subsystem 337 generates the model data 133 are provided herein in FIG. 5.

In certain embodiments, the location determining subsystem 331 is configured to determine a physical location 101 of the user device 110 (or a position which includes the location 101, an orientation, and, in some instances, additional user device 110 information) within the store environment 102. In certain embodiments, the location determining subsystem 331 determines a location 101 within the virtual model of the store represented by the model data 133 based on data received from the user device 110. For example, the location determining subsystem 331 receives location data (e.g., GPS coordinates, location data determined from a scan of a marker via the camera device 313 as depicted in FIG. 1, a network identifier detected by the user device 110 associated with a network device at a known location, or other data of the user device 110) of the user device 110 and determines a location within the virtual model corresponding to the real world location 101 (or position) within the store indicated by the user device 110 data. In certain embodiments, the location determining subsystem 331 periodically re-determines a current physical location 101 and/or virtual location for the user device 110 and communicates the determined physical and/or virtual location 101 to the subset selection subsystem 333.

In certain embodiments, the subset selection subsystem 333 is configured to provide, based on the current location 101 of the user device 110, a subset 135 of model data 133 to the user device 110. In other embodiments, instead of retrieving a subset 135 predefined by the model data generating subsystem 337 associated with a determined user device 110 location, the subset selection subsystem 333 generates, from the full model data 133, a subset 135 of the model data 133 based on the determined location of the user device 110. In an embodiment, the subset selection subsystem 333 retrieves a predefined subset 135 (e.g., predefined by the model data generating subsystem 337) associated with the location 101 of the user device 110. The retrieved subset 135 of model data 133 includes a subset of store location data 301, a subset of shelf data 302, and a subset of planogram data 303 associated with the location 101. For example, the subset of 135 of model data 133 may include a subset of store location data 301, a subset of shelf data 302, and a subset of planogram data 303 associated with an area of the virtual store model and the determined location 101 of the user device 110 is within this area. In some embodiments, the model data generating subsystem 337 stores the subsets 135 of data in the data repository 237 and associates each subset 135 with a respective predefined area of the store environment 102. In these embodiments, responsive to the location determining subsystem 331 determining the location 101 of the user device 110, the subset selection subsystem 333 determines which of the predefined areas is associated with the location 101 and then retrieves the stored subset 135 associated with the predefined area. The subset selection subsystem 333 provides the subset 135 of the model data 133 to the application 231 (e.g., to the application 311 of the user device 110 executing the application 231) for use in generating an augmented reality (AR) view 318 on the user interface 317. FIG. 1 also depicts an example display of an AR view 318 which includes virtual objects arranged on a physical reset 107 of a store environment 102 in a field of view of the user device 110.

In certain embodiments, the mixed reality rendering subsystem 335 is configured to generate, store, and/or render mixed reality views 218 (AR and/or VR views) on a user interface 317 of the user device 110. For example, the mixed reality rendering subsystem 335 generates, based on the subset 135 of model data 133 associated with the location 101 of the user device 110 a mixed reality view 218. In certain examples, the mixed reality view 218 includes an AR view that displays, from the subset 135 of model data 133, objects in the planogram data 303 in field of view of the camera device 313. In certain examples, in the AR view, one or more objects in the planogram data 303 are displayed as superimposed over areas of the store environment 201 in the field of the camera device 313 view. For example, the camera device 313 view depicts an empty physical shelf but the mixed reality view 218 depicting an AR view includes objects from the planogram data 303 superimposed on and arranged on the physical shelf in accordance with the subset 135 of model data 133. In other embodiments, a mixed reality view 218 including a VR view is displayed on the user interface 217. For example, in the VR view, the virtual model (e.g., including virtual objects arranged on a virtual shelf) is displayed based on a field of view of the user device 110.

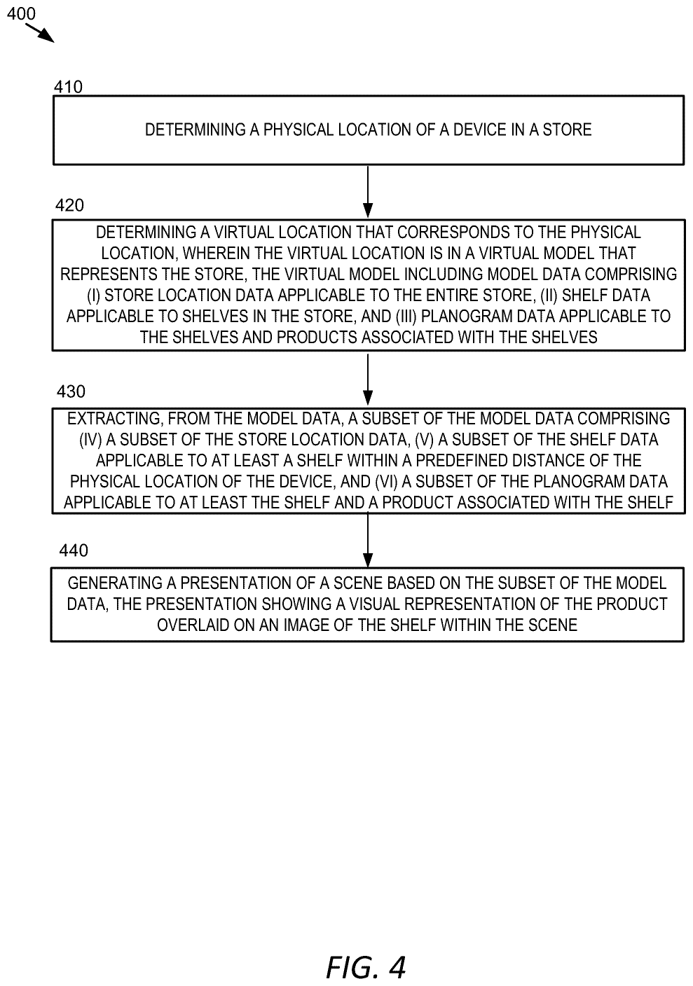

In certain embodiments, one or more processes described herein as being performed by the modeling system 130, or by one or more of the subsystems 331, 333, 335, and 337 thereof, can be performed by the user device 110, for example, by the modeling application 311. Accordingly, in certain embodiments, the user device 110 can access a subset 135 of model data 133 and generate the mixed reality view 218 based on the subset 135 of model data 133 using the method of FIG. 4, and/or can construct and/or modify model data 133 by performing one or more steps of the method of FIG. 5, without having to communicate with the modeling system 130 via the network 120.

In certain embodiments, the data repository 237 could include a local or remote data store accessible to the modeling system 130. In some instances, the data repository 237 is configured to store model data 133. The model data 133 includes store location data 301, shelf data 302, and planogram data 303 describing an entire store environment 102 of a store. In certain embodiments, store location data 301 can include a 2D layout of the store that indicates one or more locations of shelves of the store. Shelf data 302 can include dimensions of shelves indicated in the location data. For example, the store location data 301 could include horizontal dimensions of a shelf unit (e.g., length and width) and the shelf data 302 could indicate a vertical dimension (e.g., height) of the shelf unit or other data describing the shelf unit (e.g., heights of individual shelves of the shelf unit). For example, planogram data 303 could include products and/or virtual objects associated with and/or arranged on shelves. In certain embodiments, the data repository 237 stores one or more predefined subsets 135 of the model data 133, where each subset 135 includes a respective subset of store location data 301, a respective subset of shelf data 302, and a respective subset of the planogram data 303. In certain examples, the data repository 237 associates each subset 135 with a respective area of the store environment 102 so that the subset selection subsystem 333 can select the respective subset 135 if the location determining subsystem 331 determines that the user device 110 is located within the respective area associated with the respective subset 135.

The user device 110, in certain embodiments, includes an application 311, a data repository 312, a camera device 313, a GPS device 315, a user interface 317 that can display a mixed reality view 218, and sensors 219. An operator of the user device 110 may be a user of the modeling system 130.

The operator may download the application 311 to the user device 110 via a network 120 and/or may start an application session with the modeling system 130. In some instances, the modeling system 130 may provide the application 231 for download via the network 120, for example, directly via a website of the modeling system 130 or via a third-party system (e.g., a service system that provides applications for download) and the user device 110 can execute the application 231 via the application 311 (e.g., via a web browser application 311). In some instances the application 311 is a standalone version of the application 231 and operates on the user device 110.

The user interface 317 enables the user of the user device 110 to interact with the application 311 and/or the modeling system 130. The user interface 311 could be provided on a display device (e.g., a display monitor), a touchscreen interface, or other user interface that can present one or more outputs of the application 311 and/or modeling system 130 and receive one or more inputs of the user of the user device 110. The user interface 317 can include an augmented reality view which can present a subset 135 of model data 133 within the mixed reality view 218. For example, an AR view of the mixed reality view 218 includes an augmented reality (AR) scene such that model data (e.g., virtual objects on shelving units) appears to be displayed within a physical environment 102 of a user when viewed by the user through the user interface 317 in the augmented reality view (e.g., in a field of view of the camera device 313). In some embodiments, the mixed reality view 318 can include a VR view which can present model data within a VR scene such that the model data (e.g., virtual objects on shelving units) appear to be displayed within the virtual reality scene and wherein the virtual reality scene represents the physical environment 102 (e.g., a retail store) where physical counterparts of the model data can be physically located. In certain examples, the camera device 313, an AR view of the mixed reality view 218, can generate images and then augment the image by overlaying virtual objects (e.g., virtual objects from the subset 135 of model data 133 associated with the user device location 101). In certain examples, the camera device 313 can be used to determine the location 101 of the user device 110. For example, the camera device 313 can detect a marker 105 (e.g., as depicted in FIG. 1) from an image captured in the store environment 102 and determine the location 101 of the user device 110 based on image processing techniques (e.g., marker 105 detection with geometric reconstructions). In another example, the location determining subsystem 331 receives an image captured by the camera device 313 that includes the marker 105 within the captured image and determines the location 101 by applying the image processing techniques.

The user device 110 application 311, in certain embodiments, is configured to provide, via the user interface 317, an interface for generating and editing virtual objects and virtual resets (e.g., shelves including virtual objects or other arrangements of virtual objects) and for presenting AR and/or VR views 218. The application 311, in some embodiments, can communicate with one or more of the application 231 of the modeling system 130 or with the subsystems 331, 333, 335, and 337 of the modeling system 130.

The camera device 313 can provide a field of view for displaying a mixed reality view 318. For example, the user device 110 can scan the physical store environment 102 and then the application 211 can generate a mixed reality view 318 including an AR view based on the camera device 313 field of view as well as data from the subset 135 of model data 133 that corresponds to the camera field of view. In certain embodiments, the user device 110 can scan, via the camera device 313, a marker 105 (e.g., marker 105A, marker 105B, marker 105C) and then the location determining subsystem 331 can determine a location 101 of the user device 110 corresponding to the marker 105. For example, the marker 105 can be a fiducial marker having a known pattern that identifies the marker. In this example, the subset selection subsystem 333 would retrieve the subset 135 of model data 133 associated with the location 101 associated with the scanned marker 105 (e.g., the subset 135 associated with the location 101 associated with scanned marker 105 as depicted in FIG. 1) and provide the subset 135 to the user device 110.

In certain embodiments, the data repository 312 could include a local or remote data store accessible to the user device 110. In some instances, the data repository 312 is configured to store the current subset 135 of model data 133 associated with the detected location 101 of the user device 110. In some embodiments, the data repository 312 does not store the subset 135 of model data and instead the user device 110 accesses the subset 135 in the data repository 337 of the modeling system 130.

In an example depicted in FIG. 3, the user device 110 detects a marker 105A in the field of view of the camera device 313 and the location determining subsystem 331 determines a location 101 of (or position of) the user device 110 based on the detected marker 105A. For example, the user, via the user device 110, accesses or otherwise executes (e.g., via the application 311) the application 231 and selects an option to enter a mixed reality view 318 of a virtual model corresponding to the store environment 102. In other embodiments, the user device 110 detects its own location 101 based on scanning the marker 105A and transmits the determined location 101 to the subset selection subsystem 333. The subset selection system 333 selects a subset 135 of model data 133 based on the location 101 and provides the subset 135 to the user device 110 for generation of the mixed reality view 318. In some examples, the user device 110, accesses or otherwise executes (e.g., via the application 311) the application 311 to render the mixed reality view 318. In certain examples, the user interface 317 is displayed by the user device 110 in an augmented reality display mode to generate an AR view. In other examples, the user interface 317 is displayed via an augmented reality viewing device (e.g., AR glasses, an AR headset as depicted in FIG. 1, etc.) that is communicatively coupled to one or more of the user device 110 and/or the modeling system 130 to generate the AR view. For example, the mixed reality rendering subsystem 335 may render the mixed reality view 318 including the subset of model data within a camera device 313 field of view responsive to receiving, via the user interface 317, a selection of enter an AR view mode. The mixed reality rendering subsystem 335 can access the subset 135 associated with the location 101 of the user device 110 from the data repository 337 or, as depicted in FIG. 3, the data repository 312 of the user device 110 to retrieve the subset 135. The mixed reality rendering subsystem 335 renders the AR view 318 so that the user viewing the user interface 317 can view the model data (e.g., virtual objects arranged on shelving units) in the AR view in an overlay over the physical store environment 102 captured in the camera device 313 field of view.

Although each of FIG. 1, FIG. 2, and FIG. 3 depicts a distributed system (e.g., a modeling system 130 and a user device 110 that are separate from each other and that are communicatively coupled), the embodiments of the present disclosure similarly and equivalently apply to other computing architectures. For example, the user device 110 can include the modeling system 130 or can locally store copies of models (e.g., model data 133 and subsets 135 determined or generated therefrom) that are a described as being included in the modeling system 130.

FIG. 4 depicts an example of a method 400 for a method for providing, by a modeling system 130 to a user device 110, a subset 135 of model data 133 corresponding to a location 101 of the user device 110 for generating mixed reality presentations, according to certain embodiments disclosed herein. One or more computing devices (e.g., the location determining subsystem 331, the subset selection subsystem 333, the mixed reality rendering subsystem 335, and/or the application 231 included herein) implement operations depicted in FIG. 4. For illustrative purposes, the method 400 is described with reference to certain examples depicted in the figures. Other implementations, however, are possible.

In certain embodiments, as described in the following steps of method 400, the modeling system 130 or one or more subsystems thereof performs the steps of method 400. However, in other embodiments, the steps of method 400 can be performed by the user device 110 without the user device 110 needing to communicate with a modeling system 130 via the network 120.

At block 410, the method 400 involves determining a physical location 101 of a device in a store. For example, the location determining subsystem 331 determines a location 101 of the user device 110 in the store environment 102. In some embodiments, the modeling system determines a location of (or position of) the user device based on the user device scanning a physical marker (e.g., a fiducial marker having a known pattern that identifies the marker) corresponding to a known location in the store using a camera of the user device. In some embodiments, the location determining subsystem 331 determines the location 101 of the user device 110 based on global positioning system (“GPS”) or other location data received from the user device 110. In some instances, the location determining subsystem 331 is a positional determining subsystem and determines a position of the user device 110 including the location 101 and an orientation of the user device 110. In some embodiments, the location determining subsystem 331 determines the location 101 of the user device 110 by detecting the user device 110 via another device (e.g., camera, beacon device) at a known location in the store. For example, a beacon device at the store that communicates with the modeling system 130 via the network 120 detects an identifier broadcast by the user device application 231 when the user device 110 is within a predefined distance to the beacon device and the location determining subsystem 331 determines that the user device 110 is at the known location of the beacon device within the store. In another example, a camera device at the store that communicates with the modeling system 130 detects the user device 110 (or user of the user device 110) in a field of view of the camera and the modeling system 130 determines the user device 110 location 101 based on a position of the user device 110 (or the user) within the field of view. In some embodiments, the user device 110 detects a marker 105 at a location 101 in a field of view of a camera device 313 of the user device 110, applies processing techniques to determine a location 101 of the user device 110 based on an image of the marker 105 captured by the user device 110, and transmits the determined location 101 to the location determining subsystem 131 via the network.

At block 420, the method 400 involves determining a virtual location that corresponds to the physical location 101, wherein the virtual location is in a virtual model that represents the store, the virtual model including model data 133 comprising (i) store location data 301 applicable to the entire store, (ii) shelf data 302 applicable to shelves in the store, and (iii) planogram data 303 applicable to the shelves and products associated with the shelves. For example, the virtual model of the store environment 102 is represented comprises model data 133. The dimensions of the store location data 301 may be the same dimensions in virtual space as (or otherwise proportional to the dimensions of) the physical dimensions of the store environment 102. Store location data 301 can include a 2D layout (e.g., blueprint) of the store environment 102 including horizontal dimensions (e.g., length and width) of features of the store including aisle locations, shelf unit locations, wall locations, etc. Shelf data 302 can include, for shelf units/areas identified in the store location data 301, vertical dimensions (e.g., a height of the shelf unit from a floor plane) of the shelf unit/area or other features of the shelf unit/area. The other features could include a number of shelves on the shelf unit, a height of each shelf from a floor plane. Planogram data 303 can include virtual object data (e.g., virtual object representations of products or other items), which can be associated with shelf data 302. In some embodiments, location determining subsystem 331 determines the virtual location of the device in the virtual model based on a lookup that uses the physical location 101 of the user device 110 determined in block 410.

At block 430, the method 400 involves extracting, from the model data 133, a subset 135 of the model data 133 comprising (iv) a subset of the store location data 301, (v) a subset of the shelf data 302 applicable to at least a shelf within a predefined distance of the physical location 101 of the device, and (vi) a subset of the planogram data 303 applicable to at least the shelf and a product associated with the shelf. The retrieved subset 135 of model data 133 includes a subset of store location data 301, a subset of shelf data 302, and a subset of planogram data 303 associated with the location 101. For example, the subset of 135 of model data 133 may include a subset of store location data 301 (e.g., a portion of the 2D layout/blueprint), a subset of shelf data 302 (e.g., shelf data for shelves within the portion of the 3D layout/blueprint), and a subset of planogram data 303 (e.g., planogram data 303 for shelves within the portion of the 3D layout/blueprint) associated with an area of the virtual store model and the determined location 101 of the user device 110 is within this area. The predefined distance could be anywhere within a predefined area of the store location data 301 associated with the location 101.

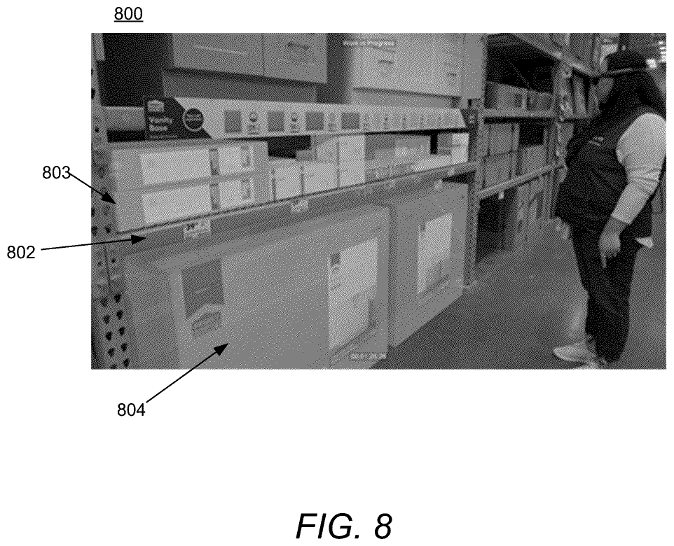

At block 440, the method 400 involves generating a presentation of a scene based on the subset 135 of the model data 133, the presentation showing a visual representation of the product overlaid on an image of the shelf within the scene. For example, the presentation could be a mixed reality view 218 (AR and/or VR view) on a user interface 317 of the user device 110. For example, the mixed reality rendering subsystem 335 generates, based on the subset 135 of model data 133 associated with the location 101 of the user device 110 a mixed reality view 218. In certain examples, the mixed reality view 218 includes an AR view that displays, from the subset 135 of model data 133, objects in the planogram data 303 in field of view of the camera device 313. In certain examples, in the AR view, one or more objects in the planogram data 303 are displayed as superimposed over areas of the store environment 201 in the field of the camera device 313 view. For example, the camera device 313 view depicts an empty physical shelf but the mixed reality view 218 depicting an AR view includes an object from the planogram data 303 superimposed on and arranged on or under the physical shelf in accordance with the subset 135 of model data 133. For example, FIG. 8 depicts an example illustration 800 of a mixed reality view 218, according to certain embodiments described in the present disclosure. As depicted in FIG. 8, a space both under and over a shelf 801 in the field of view of the user of the user device 110 is empty but, in the mixed reality view 218, images of boxed products (e.g. boxed products 802 and 803) are displayed as an AR overlay, in accordance with the planogram data 303 of the subset 135 of model data 133 from which the mixed reality view 218 was generated. Therefore, in the mixed reality view 218, the user views images of the products that would be placed on and under the shelf in the locations that the products should be placed.

In some embodiments, a mixed reality view 218 including a VR view is displayed on the user interface 217. For example, in the VR view, the virtual model (e.g., including a virtual object arranged on a virtual shelf) is displayed based on a field of view of the user device 110.

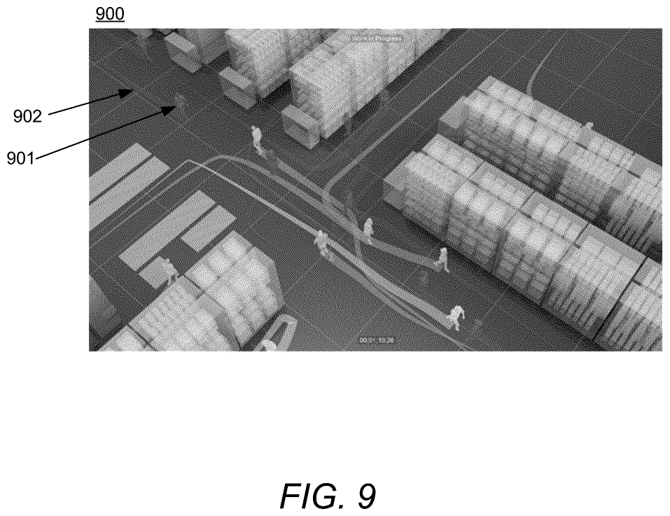

In certain embodiments, the generated presentation (e.g. the mixed reality view 218) includes shows a visual representation of the location-based statistical data within the scene which is associated with the object within the scene that is overlaid on the shelf. For example, the location-based statistical data could be foot traffic data associated with the location of the shelf, view data associated with the location of the product on the shelf, acquisition data of units of the product from the shelf, pricing information, other product information, or other statistical information. In certain examples, the mixed reality view only shows the location-based statistical data in the scene if values of the location-based statistical data greater than a predetermined value. In some examples, the mixed reality view 218 displays the location-based statistical data in the scene responsive to the user device 110 receiving an input via the user interface 217. For example, the user selects an interface object on the user interface 217 to display the location-based statistical data and the user device 110 displays the location-based statistical data in the mixed reality view 218 responsive to receiving the input. The user device 110 can retrieve the location-based statistical data to overlay in the mixed reality view 218 from the planogram data 303 of the subset 133 of the model data 135. For example, the mixed reality view 218 only shows a number of views associated with the object overlaid on the shelf if the number of views is greater than 100 or other predefined value. FIG. 9 depicts an illustration 900 of example location-based statistical data displayed in a mixed reality view 218. As depicted in FIG. 9, an overlay of foot traffic data is displayed in the mixed reality view 218. In the overlay, avatars (e.g., avatar 901) are displayed along with common paths (e.g., path 902) customers take while in the store. In FIG. 9, darker paths indicate a greater amount of foot traffic along the path compared to a lighter path.

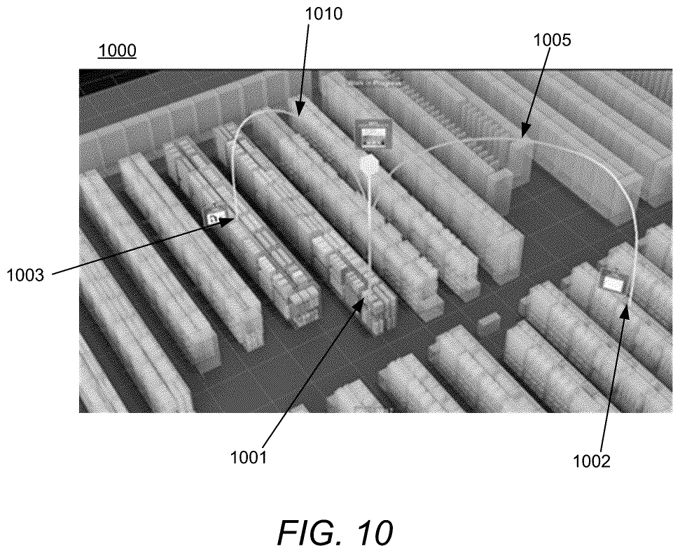

In some instances, product data displayed in the mixed reality view 218 includes sales performance data (e.g. a number of sales for each product, point of sale data for each product). In some instances, the product data displayed in the mixed reality view 218 can include heat maps and/or distance measurements of products that are frequently bought together. For example, distance measurements in the store can be shown in the mixed reality view 218 for sets of products whose joint purchase incidence is greater than a threshold. In some instances, the modeling system 130 can store these heat maps and/or distance measurements in the planogram data 303. In this example, when the user device 110 is viewing the mixed reality view 218, the mixed reality rendering subsystem 335 can retrieve the heatmaps and/or distance measurements from the planogram data 303 of the subset 133 of model data 135. The user can therefore, by selecting objects on the user interface 217, request, in the mixed reality view 218, an AR overlay of these heatmaps and/or distance measurements for display in the mixed reality view 218. FIG. 10 depicts an illustration 1000 of a distance map that can be displayed in the mixed reality view 218. The distance map indicates a distance 1005 between a product 1001 and a product 1002 and another distance 1010 between a product 1001 and a product 1003 that are frequently purchased together by customers of the store.

In certain examples, generating the mixed reality view 218 includes determining, by the mixed reality rendering subsystem 335, a field of view of the user device 110 within the mixed reality view 218 for an AR scene and determining a portion of the subset 135 of model data 133 corresponding to the field of view. In certain examples, the mixed reality view 218 includes one or more products within the portion of the subset of planogram data 303 overlaid on the image of the shelf within the AR scene. In some instances, the mixed reality rendering subsystem 335 determines an updated field of view and updates the mixed reality view 218 based on the updated field of view. For example, the updated mixed reality view 218 shows a different product on the image of the shelf within the updated field of view compared to the original mixed reality view 218 before the update. In certain embodiments, the user device application 311 determines the field of view of the user device 110 within the mixed reality view 218 for an AR scene and determines a portion of the subset 135 of model data 133 corresponding to the field of view. In these embodiments, the user device application 311 determines an updated field of view and updates the mixed reality view 218 based on the updated field of view.

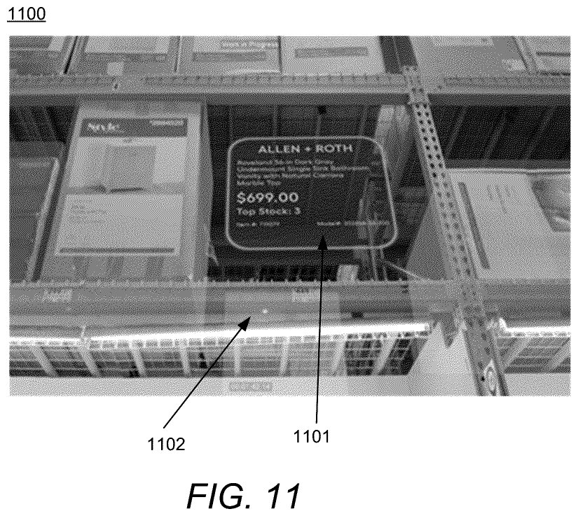

In some instances, the mixed reality view 218 provides the ability to gather and view information on obscured items on hard-to-reach shelves. For example, under normal circumstances, a store associate might need to climb a ladder to gather information on a cardboard-enclosed product held in a store's top stock. With a user device 110 in the mixed reality view 218, the associate could look up at a partially obscured cardboard box from ground level, and, select an option to enter an an X-ray view mode which displays an AR overlay in the mixed reality view 218. The AR overlay in the X-ray view mode could include a view the contents within the box of the hard-to-reach item. In some instances, the X-ray view mode could include an overlay of text at the product location that includes information from the planogram data 303 of the subset 135 of the model data 133 such as product name, product brand, product price, product dimensions, product identifiers, product weight, product availability, or other information associated with the product. The planogram data 303 in the subset 133 of model data 135 can include both a boxed version of product images (e.g. that includes a view of the products with any boxing or packaging applied) and an unboxed version (e.g. a view of product not inside the box or other packaging) for the mixed reality view 218. The mixed reality rendering subsystem 335, responsive to receiving a selection via the user interface 217 of an option to enter the X-ray view displays the unboxed version of product images as an AR overlay in the mixed reality view 218. In this example, responsive to receiving a selection via the user interface 217 of an option to exit the X-ray view, displays the boxed version of product images as an AR overlay in the mixed reality view 218. FIG. 11 depicts an example illustration 1100 of an x-ray view mode of a mixed reality view 218. As depicted in FIG. 11, in the x-ray view, product information 1101 for a product 1102 that is on a high shelf and out of reach of the user of the user device 110 is displayed in the x-ray view of the mixed reality view 218.

In some instances, in the mixed reality view 218, the user device 110 can receive one or more inputs to update the planogram data 303, shelf data 302, or store location data 301 from the user and transmit instructions to modify the data 303/302/301 in accordance with the received inputs. For example, a store associate notices an improvement that could be made to a proposed planogram for their store, they could provide feedback to the modeling system 130 while using the user device 110 in the mixed reality view 218. For example, the store associate thinks that the product should be relocated, relocates the physical product, and then relocates the product in the mixed reality view 218 so that the shelf data 302 is updated to reflect the new location of the product on a shelf unit. In some instances, the mixed reality view 218 can simulate how far customers or associates need to walk to pick up items often bought together. Associates can also test changes to product placements within the mixed reality view 218 to find optimal placements for products to enhance customer and associate experiences. The mixed reality rendering subsystem 335, responsive to receiving edits within the mixed reality view 218 to the arrangement of products and/or product information, updates the planogram data 303.

In some instances, the mixed reality view 218 can overlay, over a physical shelf in the store environment 102, a previous arrangement of items of a shelf from the planogram data 303 of the subset 135 of the model data 133, a current arrangement of items on the shelf. In some instances, the mixed reality view 218 can alternate between the previous arrangement and the current arrangement responsive to an input of the user. In some instances, the modeling system 130 can store alternate arrangements of virtual products on shelves in the planogram data 303. For example, the modeling system 130 can store a first arrangement of products on a shelf associated with a first time (e.g. year 2020) and a second arrangement of products on the shelf associated with a second time (e.g. year 2022). In this example, when the user device 110 is viewing the mixed reality view 218, the mixed reality rendering subsystem 335 can display the first arrangement of the products in the mixed reality view 218 responsive to receiving a selection of a first interface object via the user interface 217 and display the second arrangement of a second interface object responsive to receiving an input via the user interface 217. The user can therefore, by selecting objects on the user interface 217, alternate between viewing an AR overlay of the first arrangement of products in the mixed reality view 218 and viewing an AR overlay of the second arrangement of products in the mixed reality view 218.

In certain examples, the modeling system 130 (e.g. the location determining subsystem 331) determines a subsequent physical location 101 of the user device 110 in the store environment 102, where the subsequent physical location 101 is different from the physical location 101 for which the current subset 135 of the model data 133 was retrieved. In these examples, the location determining subsystem 331 determines a subsequent virtual location of the device that corresponds to the subsequent physical location 101. The modeling system 130 (e.g., the subset selection subsystem 333) can then send a query to the data repository 137 that stores the model data 133 associated with the virtual model, where the query indicates the subsequent virtual location or the subsequent physical location 101. The modeling system can then receive (e.g., via the subset selection subsystem 333), from the data repository 137, responsive to the query, a subsequent subset 135 of the model data 133 that is different from the current subset 135 and update (e.g., via the mixed reality rendering subsystem 335) the mixed reality view 318 based on the different subset 135 of the model data. In other examples, the user device 110 (e.g., the user device application 231) determines a subsequent physical location 101 of the user device 110 in the store environment 102, determines a subsequent virtual location of the user device 110 that corresponds to the subsequent physical location 101, queries the data repository 137 that stores the model data 133 by indicating the subsequent virtual location or the subsequent physical location 101, receives the subsequent subset 135 of model data 133 from the data repository 137 responsive to the query, and updates the mixed reality view 318 based on the different subset 135 of the model data 133.

FIG. 5 depicts an example of a method for generating model data for use in the computing environments of FIG. 1, FIG. 2, and FIG. 3 and in the method of FIG. 4, according to certain embodiments disclosed herein, according to certain embodiments disclosed herein. One or more computing devices (e.g., the model data generating subsystem 337 and/or the application 231 included herein) implement operations depicted in FIG. 5. For illustrative purposes, the method 500 is described with reference to certain examples depicted in the figures. Other implementations, however, are possible.

In certain embodiments, as described in the following steps of method 500, the modeling system 130 or one or more subsystems thereof performs the steps of method 500. However, in other embodiments, the steps of method 500 can be performed by the user device 110 without the user device 110 needing to communicate with a modeling system 130 via the network 120.

At block 510, the method 500 involves receiving store location data 301 including locations of shelves within a store. Store location data 301 can include a 2D layout (e.g., blueprint) of the store environment 102 including horizontal dimensions (e.g., length and width) of features of the store including aisle locations, shelf unit locations, wall locations, etc. In some instances, the model data generating subsystem 337 accesses the store location data 301 from the data storage repository 237.

At block 520, the method 500 involves receiving vertical dimensions of shelves. In some embodiments, the store location data 301 includes an indication of vertical dimensions of shelving units within the store. In some instances, the model data generating subsystem 337 receives shelf data 302 including dimensions of shelves indicated in the store location data 301. For example, the store location data 301 included horizontal dimensions of a shelf unit (e.g., length and width) but the shelf data 302 indicates a vertical dimension (e.g., height) of the shelf unit or other data describing the shelf unit (e.g., heights of individual shelves of the shelf unit).

At block 530, the method 500 involves generating a 3D representation of the shelves based on data received in 510 and 520. In some embodiments, the shelf data 302 includes the 3D representation of the shelves. In some instances, the model data generating subsystem 137 generates the 3D representation of the shelves to correspond to the horizontal dimensions of each shelf determined from the store location data 301 received in block 510 and the vertical dimension of each shelf (and other data such as a number of shelves in a shelf unit with their associated heights) determined from the shelf data 302 received in block 520.

At block 540, the method 500 involves receiving product data. For example, the product data could be the planogram data 303 described in FIG. 3. In some instances, the model data generating subsystem 337 receives planogram data could include products and/or virtual objects associated with and/or arranged on shelves represented in block 530. The user device 110 also can communicate with the data repository 237 via the network 120. In some instances, product data indicates a location of the product on a shelf within the virtual model. In some instances, product data indicates one or more of a shape of the product, a visual representation of product packaging of the product, or an image associated with the shape of the product. The shape of the product may include at least one of a height, width, or length of the product. In some instances, product data includes location-based statistical data that is based on values measured for the shelf or the product over a past period of time. For example, location-based statistical data can include one or more of traffic data (e.g. customer foot traffic data) associated with the location of the shelf, view data associated with the location of the product on the shelf, or acquisition data of units of the product from the shelf. In some instances, product data includes sales performance data (e.g. a number of sales for each product, point of sale data for each product). In some instances, product data. In some instances, the product data can include heat maps and/or distance measurements of products that are frequently bought together. For example, distance measurements in the store can be determined for sets of products whose joint purchase incidence is greater than a threshold. In some instances, the product data can include an image of an unboxed version of a product as well as an image of a boxed version of the same product, where the boxed and/or unboxed version of the product can be displayed in a mixed reality view 218. In some instances, the modeling system 130 creates 3D models of store associates to represent AI avatars as well as provide a baseline for scale in the mixed reality view 218.

At block 550, the method 500 involves generating model data 133 including associating product data with the 3D representation of the shelves. Associating the product data with the 3D representation of the shelves can include assigning, to a shelf, product data associated with a product, wherein the product data includes a product identifier, product dimensions, and a product location within the shelf. Assigning the product data can also include assigning the location-based statistical data or other product data to the products assigned to the shelves. In some instances, the modeling system 130 can generate alternate arrangements of virtual products on shelves. For example, the modeling system 130 can store a first arrangement of products on a shelf associated with a first time (e.g. year 2020) and a second arrangement of products on the shelf associated with a second time (e.g. year 2022).

In other embodiments, the virtual objects and virtual resets described herein as well as the methods to create the virtual objects and virtual resets described herein can be utilized outside of a virtual or augmented reality environment. In one embodiment, a virtual object and/or virtual reset may simply be presented as an image or a rotatable 3D object, independent of an virtual or augmented reality environment.

Any suitable computer system or group of computer systems can be used for performing the operations described herein. For example, FIG. 6 depicts an example of a computer system 600. The depicted example of the computer system 600 includes a processor 602 communicatively coupled to one or more memory devices 604. The processor 602 executes computer-executable program code stored in a memory device 604, accesses information stored in the memory device 604, or both. Examples of the processor 602 include a microprocessor, an application-specific integrated circuit (“ASIC”), a field-programmable gate array (“FPGA”), or any other suitable processing device. The processor 602 can include any number of processing devices, including a single processing device.

The memory device 604 includes any suitable non-transitory computer-readable medium for storing program code 606, program data 608, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 804 can be volatile memory, non-volatile memory, or a combination thereof.

The computer system 600 executes program code 606 that configures the processor 602 to perform one or more of the operations described herein. Examples of the program code 606 include, in various embodiments, the modeling system 130 and subsystems thereof (including the location determining subsystem 331, the subset selection subsystem 333, the mixed reality rendering subsystem 335, and the model data generating subsystem 337) of FIG. 1, which may include any other suitable systems or subsystems that perform one or more operations described herein (e.g., one or more neural networks, encoders, attention propagation subsystem and segmentation subsystem). The program code 606 may be resident in the memory device 604 or any suitable computer-readable medium and may be executed by the processor 602 or any other suitable processor.

The processor 602 is an integrated circuit device that can execute the program code 606. The program code 606 can be for executing an operating system, an application system or subsystem, or both. When executed by the processor 602, the instructions cause the processor 602 to perform operations of the program code 606. When being executed by the processor 602, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 604 store the program data 608 that includes one or more datasets described herein. In some embodiments, one or more of data sets are stored in the same memory device (e.g., one of the memory devices 604). In additional or alternative embodiments, one or more of the programs, data sets, models, and functions described herein are stored in different memory devices 604 accessible via a data network. One or more buses 610 are also included in the computer system 600. The buses 610 communicatively couple one or more components of a respective one of the computer system 600.

In some embodiments, the computer system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computer system 600 is able to communicate with one or more other computing devices via a data network using the network interface device 612.

The computer system 600 may also include a number of external or internal devices, an input device 614, a presentation device 616, or other input or output devices. For example, the computer system 600 is shown with one or more input/output (“I/O”) interfaces 618. An I/O interface 618 can receive input from input devices or provide output to output devices. An input device 614 can include any device or group of devices suitable for receiving visual, auditory, or other suitable input that controls or affects the operations of the processor 602. Non-limiting examples of the input device 614 include a touchscreen, a mouse, a keyboard, a microphone, a separate mobile computing device, etc. A presentation device 616 can include any device or group of devices suitable for providing visual, auditory, or other suitable sensory output. Non-limiting examples of the presentation device 616 include a touchscreen, a monitor, a speaker, a separate mobile computing device, etc.

Although FIG. 6 depicts the input device 614 and the presentation device 616 as being local to the computer system 600, other implementations are possible. For instance, in some embodiments, one or more of the input device 614 and the presentation device 616 can include a remote client-computing device (e.g., user device 110) that communicates with computing system 600 via the network interface device 612 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

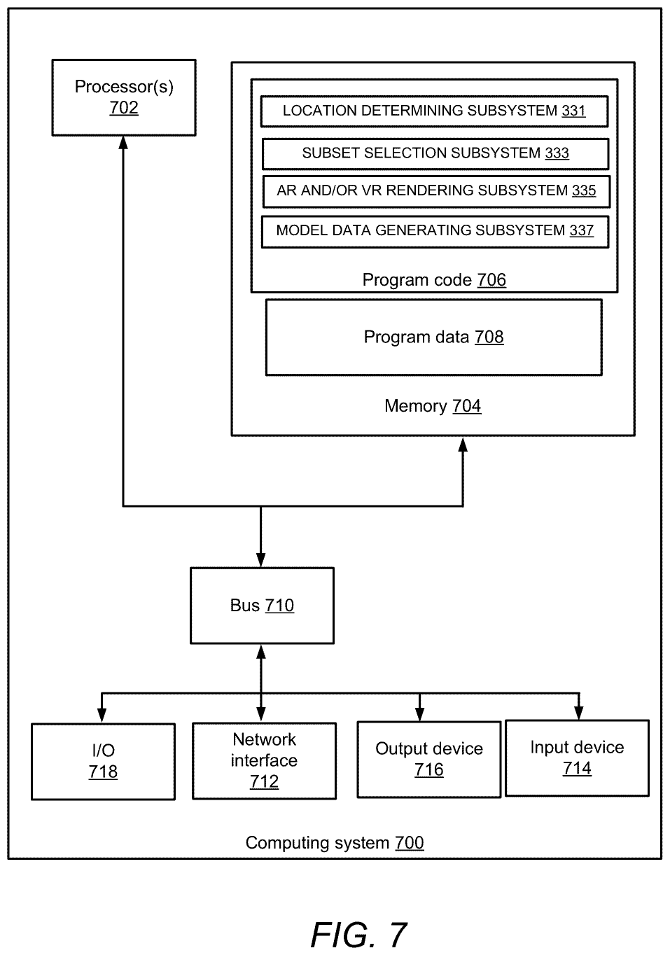

In some embodiments, the functionality provided by computer system 500 may be offered as cloud services by a cloud service provider. For example, FIG. 7 depicts an example of a cloud computer system 700 offering a service for selecting location-dependent subsets 135 of model data 133 for generating mixed reality views 218 of a store environment 102. In the example, the service for selecting location-dependent subsets 135 of model data 133 for generating mixed reality views 218 of a store environment 102 may be offered under a Software as a Service (SaaS) model. One or more users may subscribe to the service for selecting location-dependent subsets 135 of model data 133 for generating mixed reality views 218 of a store environment 102 and the cloud computer system 700 performs the processing to provide the service for selecting location-dependent subsets 135 of model data 133 for generating mixed reality views 218 of a store environment 102 to subscribers. The cloud computer system 700 may include one or more remote server computers 708.

The remote server computers 708 include any suitable non-transitory computer-readable medium for storing program code 710 (e.g., including the location determining subsystem 331, the subset selection subsystem 333, the mixed reality rendering subsystem 335, and the model data generating subsystem 337 of FIG. 1) and program data 712, or both, which is used by the cloud computer system 800 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 708 can include volatile memory, non-volatile memory, or a combination thereof. One or more of the server computers 708 execute the program code 710 that configures one or more processors of the server computers 708 to perform one or more of the operations that selecting location-dependent subsets 135 of model data 133 for generating mixed reality views 218 of a store environment 102.

As depicted in the embodiment in FIG. 7, the one or more servers providing the services for selecting location-dependent subsets 135 of model data 133 for generating mixed reality (AR and/or VR) views 318 of a store environment 102 may implement the modeling system 130 and the location determining subsystem 331, the subset selection subsystem 333, the mixed reality rendering subsystem 335, and the model data generating subsystem 337. Any other suitable systems or subsystems that perform one or more operations described herein (e.g., one or more development systems for configuring an interactive user interface) can also be implemented by the cloud computer system 700.

In certain embodiments, the cloud computer system 700 may implement the services by executing program code and/or using program data 712, which may be resident in a memory device of the server computers 708 or any suitable computer-readable medium and may be executed by the processors of the server computers 708 or any other suitable processor.

In some embodiments, the program data 712 includes one or more datasets and models described herein. In some embodiments, one or more of data sets, models, and functions are stored in the same memory device. In additional or alternative embodiments, one or more of the programs, data sets, models, and functions described herein are stored in different memory devices accessible via the data network 706.

The cloud computer system 700 also includes a network interface device 714 that enable communications to and from cloud computer system 700. In certain embodiments, the network interface device 714 includes any device or group of devices suitable for establishing a wired or wireless data connection to the data networks 706. Non-limiting examples of the network interface device 714 include an Ethernet network adapter, a modem, and/or the like. The service for selecting location-dependent subsets 135 of model data 133 for generating mixed reality views 218 of a store environment 102 is able to communicate with the user devices 704A, 704B, and 704C via the data network 706 using the network interface device 714.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method implemented by a device, the method comprising:
determining a physical location of the device in a store;
determining a virtual location that corresponds to the physical location, wherein the virtual location is in a virtual model that represents the store;
determining, from the virtual model, a subset of model data based on the virtual location, wherein:
the model data comprises (i) store location data applicable to the entire store, (ii) shelf data applicable to shelves in the store, and (iii) planogram data applicable to the shelves and products associated with the shelves, and
the subset of the model data comprising (iv) the store location data, (v) a subset of the shelf data applicable to at least a shelf within a predefined distance of the physical location of the device, and (vi) a subset of the planogram data applicable to at least the shelf and a product associated with the shelf;
generating a presentation of a scene based on the subset of the model data, the presentation showing a visual representation of the product overlaid on an image of the shelf within the scene.

2. The method of claim 1, wherein the virtual model is generated by at least:
receiving the store location data that includes a two dimensional (2D) floor plan of the store, the 2D floor plan indicating at least the shelf, a location of the shelf in the store, and horizontal dimensions of the shelf;
receiving, for the shelf identified in the 2D floor plan, at least a vertical dimension associated with the shelf;
generating a three dimensional (3D) model for the shelf based on the horizontal dimensions and at least the vertical dimension; and
generating the model data, the model data comprising the 3D model of the shelf and associating the 3D model with the location of the shelf in the store.

3. The method of claim 1, wherein the store location data includes a two dimensional (2D) floor plan of the store, wherein the shelf data indicates a type and dimensions of the shelf, and wherein the planogram data indicates dimensions of the product and a location of the product within the shelf.

4. The method of claim 1, wherein the virtual model is generated by at least:
receiving product data associated with the product, the product data indicating a location of the product on the shelf and comprising one or more of a shape of the product, a visual representation of product packaging of the product, or an image associated with the shape of the product; and
associating, in the model data, the shelf data with the product data.

5. The method of claim 4, wherein the shape of the product includes at least one of a height, width, or length of the product.

6. The method of claim 4, wherein the planogram data comprises at least a subset of the model of the product and a subset of the 3D model of the shelf.

7. The method of claim 1, further comprising:
associating location-based statistical data with the shelf data or product data that is included in the virtual model, wherein the location-based statistical data comprises first location-based statistical data that is based on values measured for the shelf or the product over a past period of time.

8. The method of claim 7, wherein generating the presentation of a scene is further based on the location-based statistical data, and wherein the presentation further shows a visual representation of the first location-based statistical data within the scene.

9. The method of claim 8, wherein the visual representation of the first location-based statistical is shown in the scene based on the first location-based statistical data indicating a value that is greater than a predetermined value.

10. The method of claim 7, wherein the first location-based statistical data comprises foot traffic data associated with the location of the shelf, view data associated with the location of the product on the shelf, or acquisition data of units of the product from the shelf.

11. The method of claim 1, wherein the planogram data is generated by at least:
assigning, to the shelf, product data associated with the product, wherein the product data includes a product identifier, product dimensions, and a product location within the shelf.

12. The method of claim 1, wherein determining the subset of the model data comprises:
sending a query to a datastore storing the virtual model, the query indicating the store and the virtual location of the device; and
receiving the subset of the model data from the datastore based on the query.

13. The method of claim 12, further comprising:
sending, to the datastore, a request to change product data in the subset of the planogram data, wherein the change is associated with at least one of a product spatial location, a product type, or a product dimension, wherein the request causes an update to the planogram data, wherein the update comprises the change to the product data.

14. The method of claim 13, the operations further comprising updating the visual representation in the scene to show the change overlaid on the image of shelf within the AR scene.

15. The method of claim 1, wherein the device is an augmented reality (AR) device, and wherein generating the presentation of the scene comprises generating a presentation of an AR scene by at least:
determining a field of view of the AR device within the AR scene; and
determining a portion of the subset of model data corresponding to the field of view, wherein the visual representation includes one or more products within the portion of the subset of planogram data overlaid on the image of the shelf within the AR scene.

16. The method of claim 15, the operations further comprising:
determining, by the AR device, an updated field of view; and
updating the visual representation based on the updated field of view, wherein the updated visual representation shows a different product on the image of the shelf within the updated field of view.

17. The method of claim 16, wherein the physical location of the AR device within the store is detected based on a marker installed in the store, and wherein the updated field of view is detected based on a set of sensors of the AR device.

18. The method of claim 1, wherein the physical location of the device is determined by:
generating, by the device, an image showing a marker installed in the store;
determining an identifier of the marker based on processing of the image;
determining, from the virtual model a physical location of the marker based on the identifier; and
determining the physical location of the device based on the physical location of the marker and the processing of the image.

19. The method of claim 1, wherein the virtual location of the device is determined from the virtual model based on a lookup that uses the physical location of the device.

20. The method of claim 1, the operations further comprising:
determining, by the device, a subsequent physical location of the device in the store, wherein the subsequent physical location is different from the physical location;
determining a subsequently virtual location of the device that corresponds to the subsequent physical location;
sending a query to a data store that stores the virtual model, the query indicating the subsequent virtual location or the subsequent physical location; and
receiving, from the data in response to the query a different subset of the model data; and
updating the presentation in the scene based on the different subset of the model data.

21. A non-transitory computer-readable storage medium comprising computer-readable instructions that, when executed by a processor, cause the processor to perform operations comprising:
determining a physical location of the device in a store;
determining a virtual location that corresponds to the physical location, wherein the virtual location is in a virtual model that represents the store;
determining, from the virtual model, a subset of model data based on the virtual location, wherein:
the model data comprises (i) store location data applicable to the entire store, (ii) shelf data applicable to shelves in the store, and (iii) planogram data applicable to the shelves and products associated with the shelves, and
the subset of the model data comprising (iv) the store location data, (v) a subset of the shelf data applicable to at least a shelf within a predefined distance of the physical location of the device, and (vi) a subset of the planogram data applicable to at least the shelf and a product associated with the shelf,
generating a presentation of a scene based on the subset of the model data, the presentation showing a visual representation of the product overlaid on an image of the shelf within the scene.

22. A system comprising:
a processor:
a non-transitory computer-readable storage medium comprising computer-readable instructions that, when executed by a processor, cause the system to perform operations comprising:
determining a physical location of the device in a store;
determining a virtual location that corresponds to the physical location, wherein the virtual location is in a virtual model that represents the store;
determining, from the virtual model, a subset of model data based on the virtual location, wherein:
the model data comprises (i) store location data applicable to the entire store, (ii) shelf data applicable to shelves in the store, and (iii) planogram data applicable to the shelves and products associated with the shelves, and
the subset of the model data comprising (iv) the store location data, (v) a subset of the shelf data applicable to at least a shelf within a predefined distance of the physical location of the device, and (vi) a subset of the planogram data applicable to at least the shelf and a product associated with the shelf,
generating a presentation of a scene based on the subset of the model data, the presentation showing a visual representation of the product overlaid on an image of the shelf within the scene.
